(19) United States
(12) Patent Application Publication
(10) Pub. No.: US 2009/0081604 A1
(43) Pub. Date: Mar. 26, 2009

(54) Method for Repositioning Teeth

(76) Inventor: Coleman Fisher, Memphis, TN (US)

Correspondence Address: BAKER, DONELSON, BEARMAN, CALDWELL & BERKOWITZ, PC, 900 SOUTH GAY STREET, 2200 RIVERVIEW TOWER, KNOXVILLE, TN, 37902, US

(21) Appl. No.: 11/858,532

(22) Filed: Sep. 20, 2007

(51) Int. Cl. A61C 3/00; A61C 11/00

(52) U.S. Cl. 433/24; 433/214

(57) ABSTRACT

A method for positioning teeth is provided. The method includes receiving a dental impression kit at an address of the dental patient. The dental impression kit includes a first dental impression tray, a mixable dental impression material, and instructions for taking an impression of the patient's teeth. The method also includes the steps of mixing the mixable dental impression material to form a settable dental impression material, and then placing the settable dental impression material into the first dental impression tray. A dental impression of the patient is made at the address of the patient. The method then includes delivering the impression to a scanning company, and in return, receiving a first orthodontic aligner from the scanning company. A plurality of additional aligners may also be received for the purpose of moving the patient's teeth to a final desired position. Preferably, the processes take place without the intervention of a dental healthcare provider.

### BACKGROUND OF THE INVENTION

1. Field of the Invention

The present invention generally relates to the field of orthodontics. More specifically, the present invention pertains to a process for gradually repositioning or realigning teeth.

2. Description of the Related Art

Orthodontics is the practice of manipulating a patient's teeth to provide better function (or “occlusion”) and appearance. Historically, the field of orthodontics has relied upon brackets or rings that are bonded to a patient's teeth. The brackets are then coupled together with an arched wire to form “braces.” The combination of the brackets and wires provides a force on the teeth, causing them to move in a pre-determined direction. Once the teeth have moved to a desired location and are held in a place for a designated period of time, the mouth adapts bone and tissue to maintain the teeth in that new position.

A fundamental objective in orthodontics is to realign a patient's teeth to positions where the teeth function optimally and aesthetically. Over a period of time, the orthodontist adjusts the appliances to move the teeth toward a final position with proper occlusion. Incremental adjustments are periodically made until the final occlusion is reached. As the teeth move towards their final positions, the orthodontist makes continual judgments based on the position of the teeth and the success of the previous step.

The process of attaching the braces to teeth is tedious and painful. Additionally, each visit to the orthodontist for an incremental adjustment is time consuming and expensive. The process is further complicated by uncertainties in determining a final arrangement for each tooth. Generally, the final tooth arrangement is determined by the treating orthodontist based on the orthodontist's knowledge and experience.

Recently, commercial orthodontic service centers have emerged that provide new types of services for orthodontists. These services include computer-assisted, three-dimensional imaging methods and CAD manipulation of tooth positions and tooth relationships. These computer-enabled services assist orthodontists in the process of improving occlusion and the straightening of teeth.

Some commercial orthodontic services have used computer-assisted technologies to develop so-called aligner systems. Aligners, sometimes called positioners, are plastic caps that are generally similar in appearance to “mouth guards.” worn by athletes. The aligners are also similar to the soft plastic appliances worn by patients to protect their teeth against the destructive effects of bruxism. Aligners serve the same role as braces in that they apply a therapeutic force on a desired portion of the patient's dental anatomy in order to cause tooth movement.

One source of aligners is Align Technology, Inc. of Santa Clara, Calif. Align Technology markets a tooth alignment system under the name Invisalign®. The Invisalign® system is described in U.S. Pat. No. 5,975,893, and several related patents, including U.S. Pat. No. 6,398,548.

An example of an aligner is shown generally at 10 in FIG. 1. The removable aligner 10 defines a polymeric shell configured to be received onto a patient's row of teeth 15. The aligner 10 defines a thin, transparent, U-shaped plastic appliance formed over patterns or models of virtual teeth. The Invisalign-type tooth aligners comprise a thinner material than the mouth guard-type appliances. Other materials are sometimes used for certain phases of the Invisalign® process.

The aligner 10 consists of a plurality of individual cavities 12, seen in FIG. 1A. Each cavity 12 is dimensioned to receive an individual tooth 16 of a patient. The teeth 16 shown in FIG. 1 are disposed along a bottom jaw of a patient. The bottom jaw is known as the mandibular portion of the jaw (or mandible) 20, and supports mandibular teeth. The lower jaw includes a jaw bone that hinges at the temporomandibular joint to the skull (not shown). The upper portion of the jaw (also not shown) is known as the maxillary portion, and supports maxillary teeth. The upper jaw includes a jaw bone that is a part of the skull. Internal to the mouth are the gums 18 and other soft tissue portions.

As illustrated in FIG. 1, the aligner 10 can be used to immediately engage the patient's teeth 15. The teeth 15 undergoing treatment may be the upper (or maxillary) teeth, the lower (or mandibular) teeth, or a subset of either of these.

To use the computer-assisted dental services, an orthodontist (or his assistant) first takes an impression of the patient's teeth. The impression may include the gums and soft tissue as well. From the impression, a positive stone model is poured and allowed to cure. However, instead of retaining the patient's models for in-office case diagnosis and treatment planning as in the past, the attending orthodontist may instead ship the patient's models to a commercial orthodontic service center, or scanning center.

It is desirable to substantially eliminate the dentist from the orthopedic process, particularly in the step of taking the impression. Accordingly, methods are provided whereby the patient is able to take advantage of the services offered by an orthodontic service center directly.

### SUMMARY OF THE INVENTION

A method for positioning the teeth of a dental patient is provided. In one aspect, the method includes receiving a dental impression kit at an address of the dental patient. The dental impression kit includes a first dental impression tray, a mixable dental impression material, and instructions for taking an impression of the patient's teeth. The method also includes the steps of mixing the mixable dental impression material to form a settable dental impression material, and then placing the settable dental impression material into the first dental impression tray.

A dental impression of the patient is made at the address of the patient. The address of the patient may be the residence of the patient, the office of the patient, or the residence of a friend or family member of the patient. However, it is not a dental office. The method then includes delivering the impression to a scanning company, and in return, receiving a first orthodontic aligner from the scanning company at the address of the patient.

A method for providing orthodontic aligners is also provided herein. In one aspect, the method includes delivering a dental impression kit to a patient. The kit is delivered to the address of the patient, and not to a dental health care provider. The address of the patient may be the residence of the patient, the office of the patient, or the residence of a friend or family member of the patient. The dental impression kit includes a first dental impression tray, a mixable dental impression material, and instructions for taking an impression of the patient's teeth.

The method also includes receiving back from the patient an impression of the patient's teeth. The impression is made from the impression material after it is mixed into a settable impression material. The impression is preferably mixed and created by the patient himself.

Based upon the impression of the patient's teeth, an initial model of at least a portion of the patient's dental anatomy is created. The model may be manually created by pouring a castable material such as gypsum into the negative impression. Alternatively, the model may be created through digital data and computer-assisted tools.

The method also includes designing an orthodontic treatment plan for moving the patient's teeth to a desired final position. From this plan a first orthodontic aligner is designed. The aligner has a polymeric shell with a plurality of cavities shaped to receive teeth for exerting a therapeutic force on a desired portion of the patient's dental anatomy. The first orthodontic aligner is provided to the dental patient, preferably at the patient's address.

In one aspect, the dental impression kit further comprises a second dental impression tray. The first dental impression tray is used to take an impression of at least a portion of the patient's maxillary teeth, while the second dental impression tray is used to take an impression of at least a portion of the patient's mandibular teeth.

Preferably, the method also includes creating a plurality of additional computer-derived models of at least a portion of the patient's dental anatomy representing incremental adjustments to the positions of the patient's teeth, creating a plurality of additional aligners corresponding to each of the additional computer-derived models, and providing the plurality of additional aligners to the dental patient, each additional aligner providing incremental, progressive adjustment to teeth of the dental patient. The plurality of additional aligners may comprise a plurality of intermediate aligners, and a final aligner for moving the patient's teeth to the desired final position.

### BRIEF DESCRIPTION OF THE DRAWINGS

So that the manner in which the above recited features of the present invention can be better understood, certain flow charts and drawings are appended hereto. It is to be noted, however, that the appended artwork illustrates only selected embodiments of the inventions and are therefore not to be considered limiting of scope, for the inventions may admit to other equally effective embodiments and applications.

FIG. 1 is a perspective view of a patient's mandibular jaw and teeth. An aligner is shown exploded above the teeth.

FIG. 1A is a cross-sectional view of the aligner, cut across line 1A-1A.

FIG. 2 is a flow chart demonstrating steps that may be taken for positioning teeth of a dental patient, in one embodiment.

FIG. 3 presents a perspective view of an illustrative dental impression tray as may be used in the method of FIG. 2, in one embodiment.

FIG. 4 is a flow chart showing steps that may be taken for providing orthodontic aligners to a dental patient, in one embodiment.

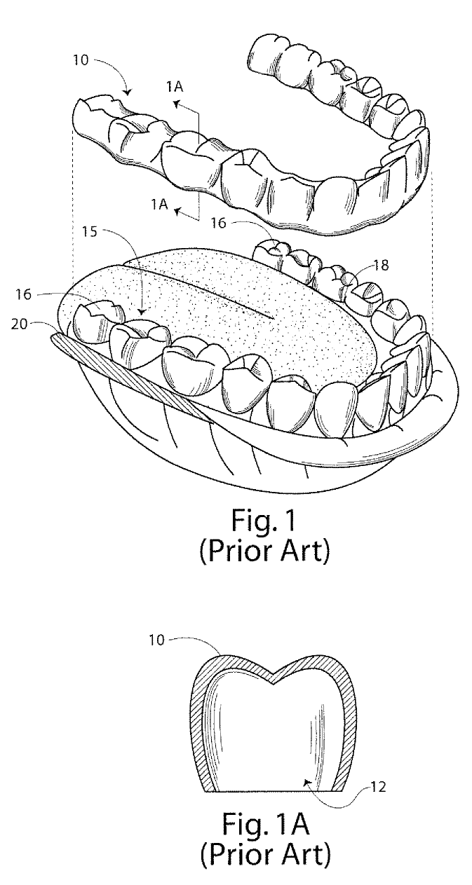

### DETAILED DESCRIPTION

### Definitions

As used herein, the term “scanning company” refers to any orthodontic center that provides appliances for moving a dental patient's teeth.

As used herein, the term “aligner” refers to any integral dental or orthodontic appliance used to move a dental patient's teeth.

The term “dental patient” means any individual in need of dental or orthodontic care for improving occlusion, straightening teeth, or otherwise changing the position of teeth.

The term “dental office” means a place of business where a dentist or orthodontist practices his or her trade.

### Description of Specific Embodiments

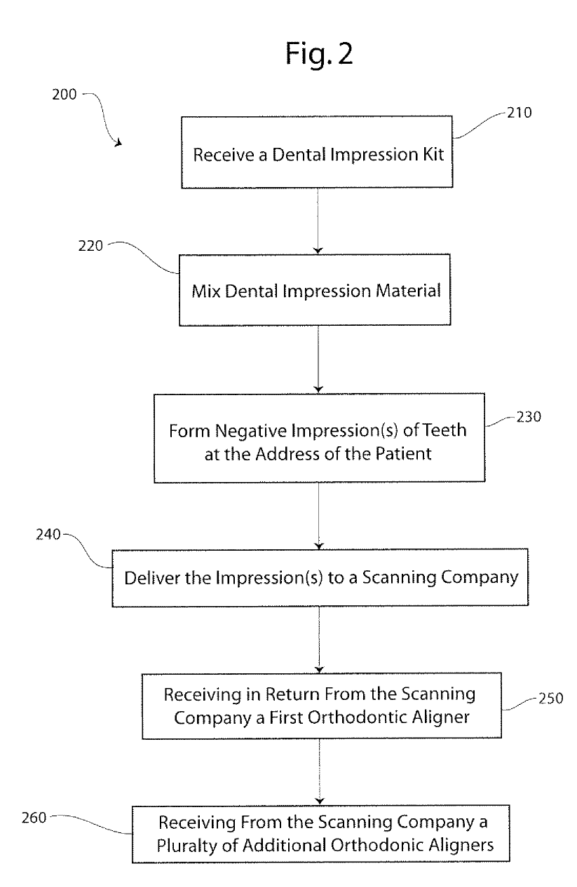

A method 200 for positioning teeth of a dental patient is provided herein. FIG. 2 is a flow chart showing a series of steps that may be provided in accordance with one embodiment of the method.

The method 200 first includes receiving a dental impression kit. The step of receiving a dental impression kit is shown in FIG. 2 at Box 210.

The dental impression kit is received at an address of the dental patient. In one aspect, receiving a dental impression kit at an address of the patient comprises the patient purchasing the dental impression kit at a retail store, and bringing the dental impression kit to his or her residence. In another aspect, receiving the dental impression kit at an address of the dental patient comprises the patient purchasing the dental impression kit at the office of a dental health care provider, and bringing the dental impression kit to his or her residence. More preferably, receiving the dental impression kit at an address of the dental patient comprises the patient ordering the dental impression kit from a scanning company, and receiving the dental impression kit directly at the patient's residence.

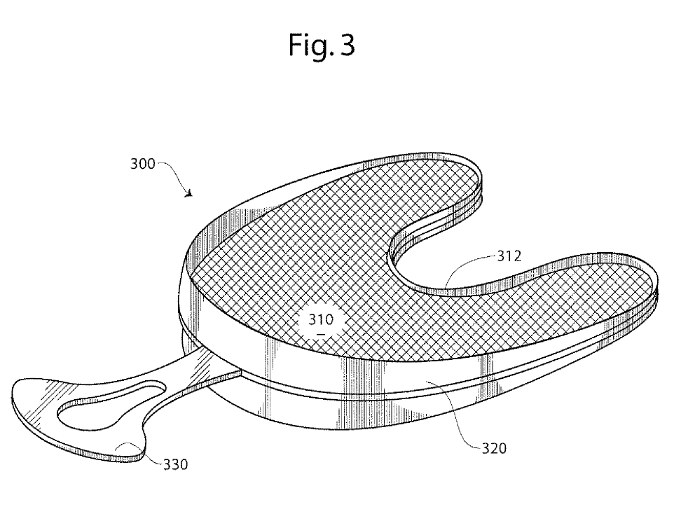

The dental impression kit includes a first dental impression tray. FIG. 3 presents a perspective view of an illustrative dental impression tray 300. The tray 300 has sidewalls 320 that are used to contain dental impression material (not shown) during the impression process. The tray 300 also has a base 310 or a mid-section separator to support the dental impression material. The base 310 defines a netting or mesh which may be fabricated from a metal, a nonwoven cellulosic material, a plastic or a gauze-like material. A handle 330 is provided for the tray 300. In addition, a lingual recess 312 is preserved.

It is understood that the present methods are not limited by the type or configuration of the dental impression tray. Indeed, there are generally five or more types of different impression trays used by dentists for various applications. These trays include a posterior tray, an anterior tray, a full arch tray, a quadrant tray, and a sideless posterior tray. Preferably, a full arch tray is provided for the step 210. In any event, the tray 300 is used as a carrier for mixable impression-forming material, and to facilitate the placement and removal of the mixed impression material in and from a patient's mouth.

Optionally, the dental impression kit also includes a second dental impression tray. In this instance, the first dental impression tray may be used to take an impression of at least a portion of the patient's maxillary teeth, while the second dental impression tray may be used to take an impression of at least a portion of the patient's mandibular teeth. The reverse may also hold true.

The dental impression kit also includes a mixable dental impression material. The dental impression material may be any known, biologically compatible, settable material. More specifically, the dental impression material may be any known pliant material that, after mixing with water or catalyst, will cure or “set” after a period of time. Known dental impression materials include alginate-based materials and silicone-based materials. Alginate materials are known for their accuracy, ease of removal from the patient's teeth, and relatively low price. Silicone-based materials tend to be highly accurate, rigid and dimensionally stable. However, they are also more expensive and may require a chemical catalyst. Silicone-based materials may specifically include polyvinylsiloxane (or “PVS”), sometimes referred to as vinyl polysiloxane (or “VPS”).

The purpose of the dental impression material is to create an impression of the patient's teeth. To do this, the dental impression material is mixed by the patient. The step of mixing the dental impression material is shown at Box 220 of FIG. 2. Typically, mixing involves pouring a dry or otherwise mixable dental impression material into a bowl, and then adding a prescribed amount of water or catalyst. The water and dry dental impression material are mixed using a spatula or other stir tool to form a settable dental impression material.

The dental impression kit also includes instructions for taking the impression of the patient's teeth. The instructions may be actual instructions provided on a piece of paper. Alternatively, or in addition, the instructions may be a telephone number that the patient calls in order to obtain guidance in mixing the dental impression material and/or taking a dental impression. Alternatively still, the instructions may be a website address that the patient may access via the worldwide web or other computer network in order to obtain guidance in mixing the dental impression material and/or taking a dental impression. Preferably, instructions in the dental impression kit explain proper procedures as are known in the dental art.

After the dental impression material is mixed, it is placed into the tray 300. The tray 300, in turn, is inserted into the patient's mouth so that a negative impression of the patient's teeth is made. Again, instructions in the dental impression kit preferably explain proper procedures. The step of forming the negative impression of the patient's teeth is shown at Box 230 of FIG. 2.

In practice, the tray is filled with a pliable, settable material such as uncured alginate putty or silicone impression material. The impression tray 300 and impression material are then introduced into the patient's mouth. An impression is made by positioning the impression tray 300 and impression material over the patient's teeth and applying pressure so that the impression material disperses around the teeth and dental arch while the dental impression material is curing.

To obtain an accurate impression, the impression material should be pushed against the teeth and gums so that there are no gaps between the teeth and gums and the impression material. To capture the patient's upper arch, the tray is inserted with the base 310 facing down. Impressions of the upper jaw typically include the teeth, the palate and gingival tissue surrounding the teeth on the facial and lingual surfaces. To capture the patient's lower arch, the tray is inverted so that the tray base 310 is disposed upwardly. Impressions of the lower jaw typically include the teeth and gingival tissue surrounding the teeth on the facial and lingual surfaces. In any instance, the patient preferably occludes against the settable impression material.

The tray 300 and impression material are seated in the patient's mouth until the material partially sets. Within a few minutes' time the material will begin to cure, but remain pliable and not distort when removed from the patient's mouth. After the impression has been made by virtue of pressing the teeth into the impression material, the tray and impression material are removed from the mouth. Excess impression material may be trimmed from the lingual recess 312 of the dental impression tray 300.

It is noted that in accordance with the method 200, the step of forming the negative impression of the patient's teeth 230 is performed at the address of the patient. The address may be the residential address of the patient. Alternatively, the address may be a business address of the patient. Alternatively still, the address may be the address of a friend or relative. In any event, the address is not the office of a dentist or orthodontist or other dental health care provider.

After the impression is taken in accordance with step 230, the tray 300 is removed from the patient's mouth. The mixed dental impression material is then partially removed from the tray 300. The cured impression material forms a negative impression of the patient's teeth and gums. The impression should essentially be an exact replica, in reverse, of the existing dentition, the surrounding tissues and support structures. Hence, it is referred to as a “negative.”

After the negative impression is formed, a positive model is created. To do this, the patient preferably returns the impression to the scanning company in a sealed plastic bag. The step of delivering the cured bite impression to the scanning company is shown at Box 240 of FIG. 2. The scanning company then creates the initial model at its office or through an immediate agent who is not a direct healthcare provider.

The scanning company receives the cured impression and creates the stone model. The model can be of all or any portion of the patient's gum line. In one aspect, the positive model is physically formed by pouring a castable material such as gypsum into the negative impression. In this way, a stone replica or dental model of the patient's teeth and gums is created. Preferably, initial models of both the mandibular and maxillary teeth are created.

Alternatively, the model is formed through a digital scanning process. In one aspect, an upper impression, a lower impression, and the bite of the patient are scanned together in a CT machine. Once scanned, the upper and lower impression scanned data is digitally reversed to make a positive. This is done by identifying the inner most surface of the impression material and extracting it from the rest of the data using, for example, a largest connected component algorithm. Once the upper and lower data is obtained, they will be aligned into a bite position using the bite material scanned.

In creating a plan for adjusting a patient's teeth, a plurality of models are created. A series of intermediate tooth positions are created in accordance with an orthodontic plan. In addition, a final tooth position is provided in a final model. Today, methods of mold making include rapid prototyping. Through the use of modern solid modeling CAD packages, combined with laser systems and new materials, solid parts may now be generated directly from a computer model. Examples of this technology include stereolithography (SLA), laminate object manufacturing (LOM), and fused deposition modeling (FDM), to name a few. Details concerning these mold-making tools are described in U.S. Pat. No. 7,037,111 (entitled “Modified Tooth Positioning Appliances and Methods and Systems for Their Manufacture”). The '111 patent is incorporated herein by reference in its entirety.

In creating the models, a computer simulation may be used to model interactions among the teeth on the jaws. The computer simulation focuses on motions involving contacts between the teeth as mounted on the jaws. The computer simulation employs software which renders realistic jaw movements that are physically correct when the teeth contact each other. The program can be used to simulate jaw movements including protrusive motions, lateral motions, and “tooth guided” motions where the path of the lower jaw is guided by teeth contacts rather than by anatomical limits of the jaws. A final occlusion determination can be made.

Based on the occlusion determination, the final position of the teeth can be ascertained. To obtain the final positions for the teeth, individual teeth may be incrementally moved in orthogonal directions. Alternatively, or in addition, individual teeth may be rotated about an established axis. Using the software, all possible free-form motions of the tooth can be performed. In order to provide for the incremental tooth positions in a patient, a plurality of aligners are made. Each aligner is fabricated on one of the sequential models, either as a physical model or a virtual model. The aligners are used to achieve proper alignment of and visual uniformity for the patient's teeth in a final position.

The aligners are preferably vacuum-formed using a combination of vacuum, pressure and heat on the various models. This is informally referred to as a “suck down” process. The term “suck down” also is related to the type of dental laboratory machine on which aligners are sometimes formed, such as a Biostar-type machine. In one aspect, each aligner is a polymeric appliance thermoformed from a thin sheet of a suitable elastomeric polymer, such as Tru-Tain 0.03, available from Tru-Tain Plastics of Rochester, Minn. Usually, no wires or other means are provided for holding the appliance in place over the teeth. In some cases, however, it will be desirable or necessary to provide individual anchors on teeth with corresponding receptacles or apertures in the appliance so that the appliance can apply an upward force on the tooth which would not be possible in the absence of such an anchor.

The shell of the desired tooth arrangement generally conforms to a patient's teeth but is slightly out of alignment with the initial tooth configuration. Placement of the elastic positioner over the teeth applies controlled forces in specific locations to gradually move the teeth into the desired configuration. Repetition of this process with successive appliances comprising new configurations eventually moves the teeth through a series of intermediate configurations to a final desired configuration. A full description of an exemplary elastic polymeric positioning appliance is described in U.S. Pat. No. 5,975,893, which is incorporated herein by reference for all purposes.

The polymeric appliances can fit over all teeth present in the upper and/or lower jaw. Often, only certain one(s) of the teeth will be repositioned while others of the teeth will provide a base or an anchor region for holding the appliance in place as the appliance applies a resilient repositioning force against the tooth or teeth to be repositioned. In complex cases, however, multiple teeth may be repositioned at some point during the treatment. In such cases, the teeth which are moved can also serve as a base or anchor region for holding the repositioning appliance.

In practice, the scanning company will create a first aligner for the patient based upon a designed plan for improving the patient's teeth alignment and/or occlusion. Various methods for designing and implementing such plans are known. Examples include U.S. Pat. No. 6,318,994 (entitled “Tooth Path Treatment Plan”), U.S. Pat. No. 6,406,292 (entitled “System for Determining Final Position of Teeth”), and U.S. Pat. No. 7,140,877 (entitled “System and Method for Positioning Teeth”). These patents are incorporated herein by reference in their entireties.

It is understood that the methods herein are not limited to the manner in which the models or the corresponding aligners are designed or fabricated. Regardless of the method used, a plan is devised for incrementally moving the patient's teeth towards a desired final position. This process starts with a first orthodontic aligner. The aligner is sent to the patient by the scanning company after the plan is devised. The step of receiving the first aligner from the scanning company is indicated at Box 250 of FIG. 2. It is noted that the dental practitioner or orthodontic specialist does not serve as an intermediary.

In addition to the first orthodontic aligner, a plurality of additional aligners are provided by the scanning company. This step is indicated at Box 260 of FIG. 2.

Overall, the aligners represent a first aligner, a plurality of intermediate aligners, and a final aligner. Each aligner may be configured so that its tooth-receiving cavities have a geometry corresponding to an intermediate or final tooth arrangement in accordance with the scanning company's treatment plan. Using the aligners, the patient's teeth are repositioned from their initial tooth arrangement (as provided by the model) to a final tooth arrangement. This is accomplished by the series of incremental position adjustments provided by the various aligners when positioned over the patient's teeth.

The additional aligners from step 260 may be provided to the patient along with the first aligner from step 250. Alternatively, the additional aligners from step 260 may be provided to the patient after the first aligner is provided from step 250. In this instance, the additional aligners may be provided individually and sequentially, or in one or more bulk mailings.

Ideally, the patient wears each aligner or appliance until the pressure of that appliance on the teeth can no longer be felt. In one aspect, the time for wearing each aligner is one to four weeks. At that point, the patient replaces the current adjustment aligner with the next aligner in the series until no more appliances remain. Conveniently, the aligners are generally not affixed to the teeth, and the patient may place and replace the aligners at any time during the process.

It is noted that the final aligner (or even the last several aligners) in the series may have a geometry or geometries selected to overcorrect the tooth arrangement, i.e., have a geometry which would (if fully achieved) move individual teeth beyond the tooth arrangement which has been selected as the “final” position. Such overcorrection may be desirable in order to offset potential rebound after the repositioning method has been terminated, i.e., to permit some movement of individual teeth back toward their precorrected positions. Overcorrection may also be beneficial to speed the rate of correction, i.e., by having an appliance with a geometry that is positioned beyond a desired intermediate or final position, the individual teeth will be shifted toward the position at a greater rate. In such case, the use of the final aligner can be terminated before the teeth reach the positions defined by the appliance.

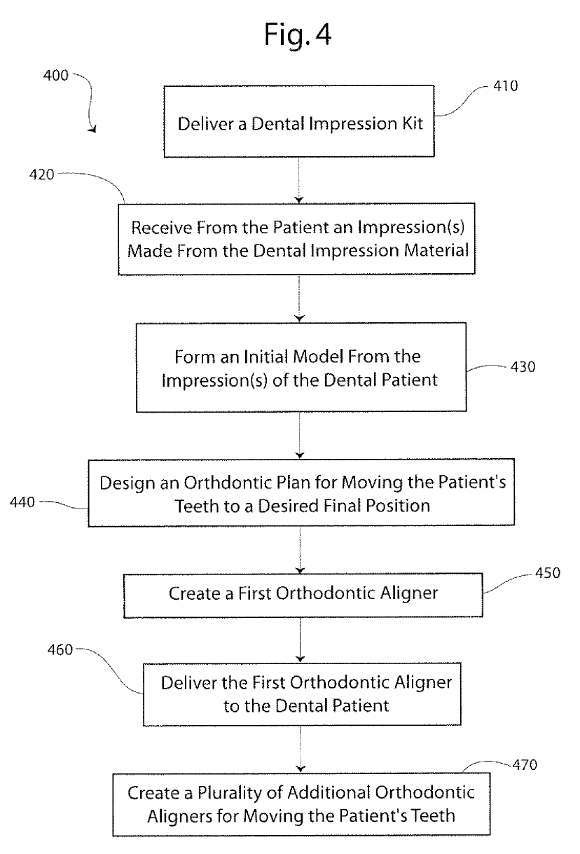

A method for providing orthodontic aligners to a dental patient is also provided herein. FIG. 4 is a flow chart showing steps for a method 400 that may be taken for providing orthodontic aligners to a dental patient, in one embodiment. The method 400 first includes delivering a dental impression kit to the address of a dental patient. This step is shown in Box 410 of FIG. 4.

As noted above, the address of the patient may be the residence of the patient. Alternatively, the address may be at the office of the patient. Alternatively still, the address of the patient may be at the residence of a friend or family member of the patient. However, it is not a dental office.

The dental impression kit that is delivered is the kit described above in its various embodiments. In its basic form, the kit includes a first dental impression tray, a mixable dental impression material, and instructions for taking an impression of the patient's teeth. These components were discussed above.

The method 400 also includes receiving from the patient an impression of the patient's teeth made from the dental impression material. This step is shown in Box 420 of FIG. 4. Optionally, impressions of both the mandibular teeth and the maxillary teeth may be received.

Based on the impression or impressions of the patient's teeth, an initial model of at least a portion of the patient's dental anatomy is created. This step is shown in Box 430 of FIG. 4. The model may be a hand-made model derived by created by pouring a castable material such as gypsum into the negative impression. Alternatively, the model may be a computer-derived model created digitally using such technology as SLA, LOM, or FDM.

The method 400 also includes designing an orthodontic treatment plan for moving the patient's teeth to a desired final position. This step is shown in Box 440 of FIG. 4. The treatment plan involves the movement of the patient's teeth through a series of incremental adjustments. Each adjustment is made by using a sequential aligner specially configured to effectuate the incremental movements of the teeth towards a final position as discussed above.

Subsequently, the method 400 includes creating a first orthodontic aligner. The first aligner has a polymeric shell that includes a plurality of cavities shaped to receive the patient's teeth for exerting a therapeutic force on a desired portion of the patient's dental anatomy. This is shown at Box 450 of FIG. 4. This first orthodontic aligner is delivered to the dental patient. Preferably, delivery is directly to the patient's address. This step is shown at Box 460 of FIG. 4.

The method 400 preferably includes steps for moving the patient's teeth towards a final position. This would include creating a plurality of additional computer-derived models of at least a portion of the patient's dental anatomy representing incremental adjustments to the positions of the patient's teeth. The method would also include creating one or more final aligners corresponding to a final position as determined by the orthodontic service center or scanning company. Thus, aligners are created to move the teeth according to the incremental adjustments provided for in the models. This is indicated at Box 470 in FIG. 4. Each of the additional aligners provides incremental, progressive adjustment to the teeth of the dental patient towards the final, desired position. The plurality of additional aligners would then be provided to the dental patient.

As can be seen, improved methods for orthodontic treatment are presented. In certain aspects, the local dental health care provider is completely removed from the process. However, it is understood that various alternatives, modifications, and equivalents may be used in lieu of the above steps. The disclosed embodiments are merely exemplary of the inventions, which may be embodied in various forms. Therefore, the details disclosed herein are not to be interpreted as limiting, but merely as the basis for the claims and as a basis for teaching one skilled in the art how to make and/or use the inventions herein.

I claim:

1. A method for positioning teeth of a dental patient, comprising:
receiving a dental impression kit at an address of the dental patient, the dental impression kit comprising a first dental impression tray, a mixable dental impression material, and instructions for taking an impression of the patient's teeth;
mixing the mixable dental impression material to form a settable dental impression material;
placing the settable dental impression material into the first dental impression tray;
taking a dental impression of the dental patient at the address of the patient;
delivering the impression to a scanning company; and
receiving, in return, from the scanning company a first orthodontic aligner.

2. The method of claim 1, wherein receiving a dental impression kit at an address of a dental patient comprises the patient purchasing the dental impression kit at a retail store, and bringing the dental impression kit to his or her residence.

3. The method of claim 1, wherein receiving a dental impression kit at an address of the dental patient comprises the patient purchasing the dental impression kit at the office of a dental health care provider, and bringing the dental impression kit to his or her residence.

4. The method of claim 1, wherein receiving a dental impression kit at an address of the dental patient comprises the patient ordering the dental impression kit from the scanning company, and receiving the dental impression kit at the patient's residence.

5. The method of claim 1, wherein the first orthodontic aligner is received from the scanning company at the address of the patient.

6. The method of claim 1, wherein the settable material is an alginate material or a silicone-based material.

7. The method of claim 1, wherein the dental impression kit further comprises a second dental impression tray, the first dental impression tray being used to take an impression of at least a portion of the patient's maxillary teeth, and the second dental impression tray being used to take an impression of at least a portion of the patient's mandibular teeth.

8. The method of claim 1, further comprising:
forming a positive model of the patient's teeth from the impression.

9. The method of claim 1, wherein the address of the patient is the residence of the patient, the office of the patient, or the residence of a friend or family member of the patient.

10. A method for providing orthodontic aligners, comprising:
delivering a dental impression kit to the address of a dental patient, the dental impression kit comprising a first dental impression tray, a mixable dental impression material, and instructions for taking an impression of the patient's teeth;
receiving from the patient an impression of the patient's teeth made from the dental impression material;
based upon the impression of the patient's teeth, creating an initial model of at least a portion of the patient's dental anatomy;
designing an orthodontic treatment plan for moving the patient's teeth to a desired final position;
designing a first aligner having a polymeric shell with a plurality of cavities shaped to receive teeth for exerting a therapeutic force on a desired portion of the patient's dental anatomy; and
providing the first aligner to the dental patient.

12. The method of claim 10, wherein the dental impression kit further comprises a second dental impression tray, the first dental impression tray being used to take an impression of at least a portion of the patient's maxillary teeth, and the second dental impression tray being used to take an impression of at least a portion of the patient's mandibular teeth.

13. The method of claim 10, wherein the initial model is a computer-derived model.

14. The method of claim 10, wherein the initial model is a hand-poured positive made from the impression of the patient's teeth.

15. The method of claim 13, further comprising:
creating a plurality of additional computer-derived models of at least a portion of the patient's dental anatomy representing incremental adjustments to the positions of the patient's teeth;
creating a plurality of additional aligners corresponding to each of the additional computer-derived models; and
providing the plurality of additional aligners to the dental patient, each additional aligner providing incremental, progressive adjustment to teeth of the dental patient.

16. The method of claim 15, wherein the plurality of additional aligners comprises a plurality of intermediate aligners, and a final aligner.

17. The method of claim 10, wherein the address of the patient is the residence of the patient, the office of the patient, or the residence of a friend or family member of the patient.

18. The method of claim 15, wherein:
providing the plurality of additional aligners to the dental patient is by sending the aligners to the address of the patient; and
the address of the patient is the residence of the patient, the office of the patient, or the residence of a friend or family member of the patient.

19. The method of claim 1, wherein the settable material is an alginate material or a silicone-based material.

20. A method for positioning teeth of a dental patient, comprising:
receiving a dental impression kit at an address of the dental patient, the dental impression kit comprising a first dental impression tray, a second dental impression tray, a mixable dental impression material, and instructions for taking an impression of the patient's teeth;
mixing the mixable dental impression material to form a settable dental impression material;
placing the settable dental impression material into the first dental impression tray and the second dental impression tray;
using the first and second dental impression trays, taking dental impressions of the patient's mandibular teeth and the patient's maxillary teeth at the residential address of the patient;
delivering the impression to a scanning company;
receiving, in return at the patient's residence, from the scanning company a first orthodontic aligner having a polymeric shell with a plurality of cavities shaped to receive the patient's teeth for exerting a therapeutic force on a desired portion of the patient's dental anatomy; and
receiving at the patient's residence from the scanning company a plurality of additional orthodontic aligners defining polymeric shells, each with a plurality of cavities shaped to receive the patient's teeth for exerting a therapeutic force on a desired portion of the patient's dental anatomy for the purpose of moving the patient's teeth to a final desired position.
